(19) United States
(12) Patent Application Publication
(10) Pub. No.: US 2003/0157963 A1
(43) Pub. Date: Aug. 21, 2003

(54) Selective intercommunication 1 device for mobile terminals in physical proximity, also linked by global networks

(76) Inventor: Laurent Collot, Paris (FR)

Correspondence Address: Blakely Sokoloff Taylor & Zafman, Seventh Floor, 12400 Wilshire Blvd, Los Angeles, CA, 90025-1026, US

(21) Appl. No.: 10/240,285

(22) PCT Filed: Mar. 27, 2001
(86) PCT No.: PCT/FR01/00925

(51) Int. Cl. H04M 1/00

(52) U.S. Cl. 455/557; 455/554

(57) ABSTRACT

The invention concerns a selective intercommunication system comprising a plurality of mobile terminals capable of being carried by a plurality of users and comprising means for exchanging in pairs, in particular when physically proximate, and means for verifying whether all data exchanged correspond to compatibility criteria for which said terminals have been programmed. The invention is characterised in that it comprises a server capable of interfacing with the mobile terminals to transmit thereto data and programme them and to which the users can be connected via a global network, such as Internet, to configure the mobile terminals, via said server.

Modern technology is providing an abundance of communication means, which allow individuals quasi-permanent connection to quite a number of global networks. The generalization of cellular mobile telephones, or tomorrow that of satellite telephones is a striking example. However, these means of communication address only one of the aspects of information exchange: the putting of an individual into communication with the entire network. The interconnection of a group of individual is therefore virtual, since each linkup necessarily goes through a node of the global network.

On the other hand, most human transactions go through a step of direct sensory recognition, during a fortuitous or planned physical encounter. This is of course the case when two individuals meet, and also when seeking resources. In all these cases, the action can be summarized as a physical encounter, followed by a selection process which allows the individuals to identify the most relative contacts. These relational mechanisms, which are very expensive in terms of time and energy, are very often hindered by innate blockages, or by those acquired during life in society. Global means of communication do not allow efficient disabling of these blockages, since they do not fundamentally resolve the question of objective choice of the partner or partners with which to communicate. Finally, recourse to a human third party does not generally make it possible to dispense with doubts as to the reliability of the intermediary.

A general aim of the present invention is to propose a novel, selective and adaptive mechanism for automatically putting individuals in touch with other physical persons or automata. This mechanism for compensating for blockages makes it possible as it were to “devirtualize” cyberspace by reintroducing into it the concept of physical proximity.

Apparatuses such as those marketed under the name Lovefinder or Love-gety have already been proposed, these being very compact, portable apparatuses which continuously transmit a signal selected by the user during setup and which code a desired type of relation (“dinner, talk, fun, flirt, drink”). When two apparatuses configured in the same way cross less than a few meters apart, a luminous or audible signal is transmitted, this being sensible to favor an encounter between the two possessors of the apparatus.

Nevertheless the capabilities of such devices are limited: the user can choose only between a few very simple criteria, preselected by the manufacturer and unalterable.

Moreover, the action triggered (audible or luminous signal) remains rudimentary.

Improving the possibilities of these apparatuses would involve the implementation of an advanced, and therefore bulky, user interface.

IBM has also proposed, within the framework of a technological demonstration, devices called Thinking Tags (2) which adopt substantially the same logic, while permitting more flexibility in the choice of criteria: the user talks by infrared link to a collection of stations, each dedicated to a criterion. The set of criteria can be modified by reconfiguring the various stations. However, this reprogramming is the remit of the operator of the infrastructure and not of the users who must therefore adhere to one and the same set of criteria.

A similar concept, called Hot Badge, has been proposed by Philips Design (3).

Furthermore, intelligent portable devices are the subject of various studies.

In particular, Digital Research is working on a project for portable devices, called Factoids (4), each capable of detecting information transmitted by other identical devices so as to retransmit it immediately to a server. The data are then harnessed by the user who is thus furnished with a second memory. One of the drawbacks of this concept is the nonselectivity of acquisition of the information giving rise to considerable sifting work.

Media Lab is also studying a portable device, this one being called Rememberance Agent (5), making it possible, as a function of circumstances, to offer the user information which is relevant within the context. The system described affords shrewd harnessing of a database constructed by the user but does not provide for information exchanges with other devices.

With a view to short-distance communication, IBM has proposed a system called PAN (Personal Aera Network) (6) allowing two people to exchange data (for example the contents of a calling card) via a handshake. However, the possibilities of the device are restricted to communication between two cooperative protagonists in physical contact, disposed to shake hands.

As will have been understood, these various systems are all limited in their application and do not allow the flexibility in the choice of criteria which can be enjoyed for example on the WWW network when using search engines required for harnessing the immense amount of information available; provided that they are known to the search engines, any person, any object, any service complying with a set of very precise criteria can be found.

Nevertheless, the meeting remains virtual.

The connecting of a portable computer or of a PDA to the WWW network via a wireless link allows the user to interact better with his environment, while benefiting from the data available on the network and from the selectivity of the search engines: sensory experience can thus be supplemented with information found on the network.

It is possible to envisage, adopting the approach of Theimer et al. (7), an architecture in which mobiles are fitted with a locating device and communicate with one another via the network, a central server knowing at any instant the position of the mobiles and organizing the routing of the information accordingly. If this architecture is conceivable on the scale of a building, a community of average size and a local network, it is difficult to install on a large scale: in particular it would require permanent links between all the mobiles and the cellular network.

### GENERAL PRESENTATION OF THE INVENTION

The present invention proposes a system which does not exhibit the limitations of the prior art systems.

To this end, the solution proposed by the invention is a system for selective intercommunication comprising a plurality of mobile terminals which are able to be carried by a plurality of users and which comprise means allowing them to exchange pairwise, in particular when they are located in proximity to one another, as well as means allowing them to verify that the data which they exchange satisfy compatibility criteria for which said terminals have been programmed, characterized in that it comprises a server which is able to talk to the mobile terminals so as to send them data and program them and with which the users can connect by way of a global network, such as the Internet network, in order to configure the mobile terminals, by way of said server.

This system is advantageously supplemented with the following various characteristics taken alone or according to all their technically possible combinations:

it comprises at least one local network within which the mobile terminals exchange;

it comprises means making it possible to determine an information item regarding physical proximity between two mobile terminals and means which authorize the data exchanges between two mobile terminals only when a condition on this information item regarding proximity is satisfied;

the mobile terminals comprise a Man Machine Interface allowing a user to configure them directly;

the mobile terminals comprise means allowing their automatic reconfiguration on receipt of a character transmitted by a third party mobile terminal;

the mobile terminals comprise sensors for measuring physical quantities and the exchange of data between two mobile terminals is authorized only when a condition relating to at least one of these physical quantities is complied with;

a mobile terminal comprises means for transmitting a wakeup signal, as well as means for transmitting a signal in response to the detection of such a wakeup signal;

it comprises a plurality of fixed terminals to which the mobile terminals are able to talk;

the fixed terminals comprise display means able to display data received from a mobile terminal;

a mobile terminal comprises means allowing it to retransmit data received from a third party mobile terminal;

a mobile terminal comprises memory means in which the data corresponding to a request formulated by the user of the mobile terminal persists for as long as it has not been satisfied.

Other characteristics and advantages of the invention will become further apparent from the description which follows which is purely illustrative and nonlimiting and which should be read in conjunction with the single appended figure, in which is represented the general architecture of a system in accordance with an embodiment of the invention.

### DESCRIPTION OF THE INVENTION

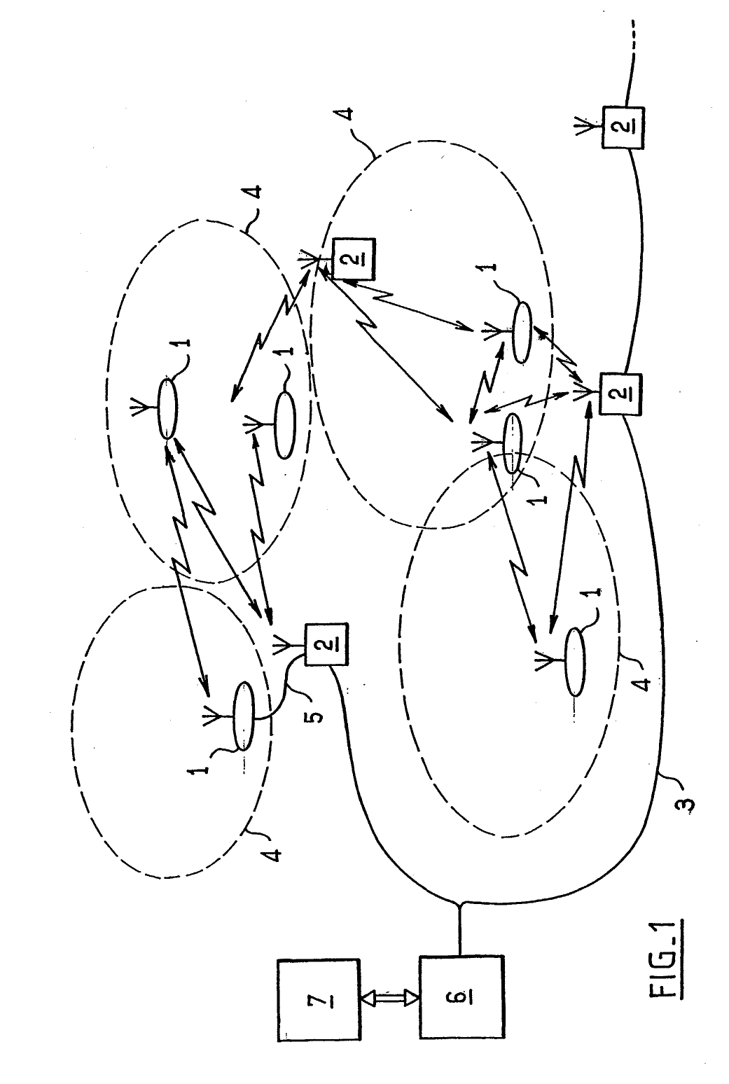

The system represented in FIG. 1 comprises a collection of autonomous mobile apparatuses 1 transported by individuals (or vehicles) and an infrastructure comprising a certain number of fixed nodes 2 and allowing the permanent or temporary connection of the mobiles 1 to a global interconnection network. The mobiles 1 and the nodes 2 of the communication infrastructure also all comprise facilities allowing the storage and the processing of information, and optionally acoustic, tactile and visual means of interaction with human operators. Finally, the mobiles and certain nodes of the global network are fitted with means of communication over the airwaves or optronic means of communication allowing connection and exchange of digital information, at short range.

### CONCEPTS AND VOCABULARY

Throughout the subsequent text, the following terminology is used:

Keys: data exchanged and their typology

Methods: the means of acting on the keys, that is to say programs or fragments of programs carrying out operations of storage, duplication, erasure, transmission, comparison (operation also called “differencing” subsequently), etc. on said keys (and more generally on the data blocks in which said keys are encapsulated, if appropriate with said programs or fragments of programs).

Actions: particular method executed in reaction to a result of differenceles actions induced by any operation on these data.

Character: block of structured, optionally compressed and encrypted, data which contains keys and also methods. The associating of the keys and methods (operators) allowing their autonomous processing is the foundation stone which allows the deployment of the functionalities described in the introduction, such as the defining of the context of applicability when two mobiles carrying heterogeneous information “meet”, and appropriate reactions induced by the operators included in the activated character(s). (For example, a type of particular data, an operator for comparing these data with other data of a similar type, and a particular reaction on the man/machine interface.) An exemplary structure of such characters is given hereinbelow.

A comparison operation can for example be an evaluation of an abstract topological distance between two keys, with a view to deciding as to the relevance of a possible encounter between these two keys.

### ELEMENTARY COMPONENTS

A certain number of components of the system of FIG. 1 will now be described, and in particular the communication facilities, the information processing, storage, man/machine interface (MMI) facilities, various interfaces or sensors (optional) and various classes of software components. Of course, the various items of electronic equipment are furnished with appropriate power supplies (accumulators, mains, etc.).

Communication Facilities

1. A (or several) global digital communication network 3, allowing the bidirectional exchange of digital information, such as for example the Internet network (over Ethernet, token ring, ATM, etc.), the switched wire telephony network (STN), the wireless digital telephony networks (to the GSM, DCS standard, etc.), or the satellite telephones (Immarsat, Iridium, Teledesic, etc.).

2. A (or several) local digital proximity network 4, dedicated to the application. It may be of the radio kind (high frequency or microwave) or optronic kind (infrared).

In all cases the transport mechanism chosen must allow the interference-free conveying of numerous channels in parallel and be tolerant in respect of jamming sources.

The ability to effect an exclusive logical connection of one terminal (mobile or station) with one or more others without interference is vital. Additionally, technologies making it possible to define several logical subnetworks among a collection of terminals, all in zones of mutual radio coverage will be preferred.

Finally, for certain applications, a process for evaluating the distance separating two connected terminals is implemented. A process of radio connection offering all these functionalities is described in detail in the exemplary embodiments.

In the case where recourse to a purely local network would not be desirable or achievable, on account of limitations of range for example or of granting of frequencies, it is possible to envisage “emulating” a local network by means of a global network, provided that the physical proximity of the terminals with respect to the nodes of the global network is determined. In this case, it is sufficient for a centralized server, capable of locating, absolutely and individually, the mobile terminals within its perimeter of visibility and hence of calculating their mutual spacing, or in certain cases (cellular networks for example) of simply deciding whether two mobile terminals belong to the same communication cell, to keep up to date a table cataloging the mobiles which satisfy a given spacing criterion (belonging to the same cell of the network, being less than n meters apart for example, etc.). If the information contained in this table is accessible remotely by the mobiles, or if the managers of the network perform a selection of the mobiles in physical proximity (by activating them preferentially for example), it is possible to perform operations requiring a proximity criterion without ever directly measuring the distance between two mobile terminals.

For example, a cellular network of GSM type makes it possible to carry out this function by simply searching through the membership table (giving the various cells to which the mobiles belong), which table is automatically updated by the base stations of the network. It is then easy to determine groups of mobiles belonging to one and the same cell (or microcell), and hence in physical proximity.

Certain devices for the fine locating of mobiles on the basis of the times of propagation of waves to at least three base stations are also usable.

3. An auxiliary and optional bidirectional digital connection 5 from the mobiles to the fixed nodes of the global network. A simple serial wire link is possible (RS232), or an infrared link (IrDa), or an inductive link etc. More advanced addressed and arbitrated interfaces such as USB, ieee 1394 or SCSI are also usable.

Information Processing Facilities

1. Autonomous computers especially at the level of the server of the network (referenced 6) and of the nodes 1 and 2, allowing the execution of static or dynamic programs. In the mobile terminals, this will usually involve a low-consumption microprocessor.

2. A volatile or nonvolatile memory allowing the storage and readout of digital information. A database 7, which exchanges with the server 6 of the network, is provided in particular.

3. A man machine interface allowing display, transmission of sounds and manual, tactile or voice input of information. These interface systems can be integrated into the mobile devices or form part of other nondedicated computing equipment.

4. An encryption and decryption unit (optional), hardware or software allowing at one and the same time secure exchange of information between fixed and mobile stations and possibly their identification at the network.

Electronic Functions and Miscellaneous Sensors

1. Device allowing the allocation of a unique identification number to each mobile (or fixed) station. It may simply be a value stored in a read only memory (ROM), or for greater safety a “smart card” protected by a cryptographic access mechanism

2. Clock allowing the date-stamping of events

3. Device for approximate measurement of the distance between two mobiles connected up. Refer specifically to the section dealing with the connecting up of two mobiles via the proximity network.

4. Absolute global satellite-based positioning system (GPS) or relative device for location with respect to the physical nodes of the global network.

5. Any sensor allowing the measurement of a straightforward physical quantity (temperature, pressure, magnetic field, etc.)

Software Components

1. Operating system for the fixed and mobile stations. This software ensures the management of the various electronic facilities, orchestrates the dynamic execution of the programs (that is to say of the methods), and ensures the vital functions of the terminals: connection & routing of the networks, transport, dynamic memory management, or utilization of the MMI. The latter allowing the representation of digital data or signals in a form intelligible to man, and also the human input of information.

2. Program interpreter/compiler, allowing the interpretation, selection and execution of the programs contained in the “characters”. The latter can be altered and can be reprogrammed at will, and may be exchanged between the mobiles and the nodes by means of the global interconnection network.

3. Local bases of “characters”, carried on board the mobile devices, or based in stationary computers (centralized databases). This component ensures the storage and retrieval of the “characters” manipulated by the program interpreter/compiler.

4. Indexing and cryptography system, allowing the generation of keys from the “characters”. This mechanism is essential for ensuring that the characters present in the two terminals connected by the proximity network have any contextual linkup. Indexation allows the transfer of information in an optimal compressed form. Moreover, recourse to encryption makes it possible to avoid unenciphered disclosure on the radio waves of the “characters” of a terminal.

5. System for transporting the “characters” or keys identifying them by the physical means of communication.

### MAIN OPERATING STEPS

To clarify the presentation, three operational modes are distinguished hereinbelow. However, when a device comprises numerous fixed and mobile terminals interacting, these modes coexist simultaneously at various points of the system.

Programming and Configuration

When a new terminal, which is either fixed or mobile, is added to the network, a preprogramming step is required. Let us consider here only the aspects of the systems relating to the “characters” proper, and not to the infrastructure of the global device. Of course, the numerous servers which make up the backbone of the global network will have to be programmed accordingly in order to ensure the novel functionalities described in this patent.

Several modes of configuring the terminals can be envisaged:

“On line” configuration via Internet. In this mode, the “characters” are generated mechanically by a combination of choices which is made by the user via a “web form”, or which are built dynamically “on the fly” by the web server (like the CGI) as a function of parameters accessible to the server. Of course, wire or wireless connection to a node of the global network is required in this mode. In this mode the mobile terminals can be regarded as being programmed by information generated by or stored on the servers of the global network.

Configuration via the MMI (Man Machine Interface) of the mobile terminals. In this mode, configuration can be performed in situ, this in fact being its attraction. The user, by stringing together choices of parameters, “configures” a type of parameter preexisting in his mobile terminal.

Automatic, following the receipt of a preexisting “character” transmitted by a third party terminal after a communication channel has been established with the latter. This mechanism therefore allows the automatic “reprogramming” of a remote terminal and the sending of an “acquired” functionality via the network.

Operation of the Mobile Terminals in Interactive Mode

On completion of the step of configuring the mobile terminals, each active mobile device periodically transmits particular interrogation sequences allowing their identification at other mobiles or fixed stations: this mechanism allows the establishment of local connections, which define a collection of point-to-point linkups, also dubbed a subnetwork (local networks 4). The mobile devices then exchange in a bidirectional manner, with their closest neighbors included in the physical and logical intercommunication “bubble”, keys characteristic of the characters stored in their respective memories. The various nodes (beacons 2, mobiles 1) of the network can be programmed, possibly remotely from the server 4 or from another terminal, so as to permit intercommunication only when certain context conditions are met, these conditions being satisfied for example by using the information emanating from the auxiliary sensors. Such a condition is for example a condition on the distance which separates each of the terminals of the subnetwork. This can be accomplished by measuring the RF or optical power detected, or else by measuring the propagation time of the electromagnetic signals.

If the exchanges between the mobiles ensure that certain characters associated with at least two mobiles are pairwise compatible, the corresponding actions are then triggered.

The string of steps required for such a transaction is the following:

Selection by the initiating terminals: this step, initiated by an active terminal 1 or 2, is aimed at determining the mobiles or fixed nodes which may be in radio contact with it, and in no way constitutes a guarantee that the terminals have relevant information to exchange (indeed, in most cases this requires a program to be executing in the potentially target terminal, the latter not necessarily being receptive at this instant). However, in order to limit radio traffic and to decrease the number of mobiles simultaneously connected, the wakeup sequences could contain keys distinguishing various standby modes. This is essential if the standard used to communicate involves types of equipment other than terminals of the system, which must necessarily “converse” with other terminals of the system. Specifically, since the device relies on standardized digital means of radio communication, other equipment may have to share the band. Also, it is necessary to carry out a prior identification of the kind of apparatuses present. In the “Bluetooth” standard for example, this is carried out just after the phase of initiation of the pseudo-random frequency jump sequence by mutual exchange between the mobiles of a short key describing the capabilities of the terminal. These descriptions, in a word, contain information on the category of “bluetooth” terminal (helmet, video camera, printer, etc.) and the type of data expected (audio or video stream, printable data, etc.). The terminals of the system would simply constitute a new category of terminal, manipulating data which are more or less hermetic to the other categories.

Waking up of the slave terminals: the electronics of the target terminals performs a “passive” monitoring of certain channels. When the radio receives a particular wakeup sequence originating from an active terminal 1 with broad spectrum (pseudo-random), the computer of the terminal is “woken up” and the sequence is fed to it. If the wakeup key corresponds to a suitable class of devices, the “woken up” terminal then transmits an agreed response to inform the initiator of its new state. In the case of radio networks using type I technologies it is generally necessary at this juncture to mutually synchronize the pseudo-random transmission sequences of the terminals. These prefatory steps of preconnection are generally deployed either through the use of dedicated control channels (GSM) or through techniques of systematic polling of the channels for detecting the connection sequences (Bluetooth). In all cases, the establishing of a communication pathway, logical or physical, which is independent of the main traffic is necessary. On completion of this step, the radios of the terminals are capable of exchanging information (although in a not absolutely reliable manner on account of collisions or jamming) but the logical connection is not effected.

Transmission of a connection criterion & Management of collisions: the initiating terminal then transmits certain information in the newly opened main communication channel so as to ensure the logical connection, that is to say the identification of the terminals connected up. This is generally carried out by means of a key unique to each apparatus. This key can of course contain information allowing hierarchical communication of certain classes of terminals. At this junction, and for all the logical communications, the collisions (when several terminals are transmitting simultaneously) are automatically detected by adding a protocol to the message sent, allowing verification of the integrity of the message sent and even automatic correction of errors by virtue of some redundancy (error correcting codes). The data can also be encrypted before transmission and decrypted by the receiver.

Simultaneous connection of several subnetworks: owing to the unique identification of the terminals, this type of connection even allows the defining of subnetworks of terminals connected together, but logically independent (DECT, Bluetooth, HomeRF).

Exchange of keys relating to “characters”: in accordance with the program installed in the mobile terminals, a first list of keys specific to the active “characters” in the initiating terminal is transmitted to the other connected terminals.

Comparison of keys: automatic or semiautomatic comparison of the keys sent with the local “character” keys contained in the target mobiles. The compatibility of the keys (“matching”) is evaluated by means of methods for calculating the “differences” included in the local “characters” themselves. These methods are none other than particular “actions”. This evaluation may be simple (comparison of keys for identicalness) or more complex (implementation of calculation of Baylesian expectations), especially if the “characters” are themselves composed of subcharacters (cf. exemplary embodiment).

Triggering of “actions” associated with “characters”. The actions determined by the results calculated by the programs included in the “characters” bring about the activation of system functions or software functions of the terminals. The exchange of information can therefore trigger the intervention of a human operator, in response to a warning signal or message, or else bring about an automatic action. Human operators may also modify the overall behavior of the system via the global network, by deciding at any moment to remotely reprogram the mobile or fixed agents by deciding to send back an appropriate “character”.

Harnessing of Interactions

In reality this functional step resembles the configuration operations. In many cases, the two steps will be performed simultaneously, the earlier results being able to decide the new programming, by downloading new “characters”, of the terminals.

On line, on the Web

During episodic reconnections of the mobile terminals to the local network, these terminals may, by activating certain of their default methods, connect up via the transport protocol of the global network to identified “web” servers (identified on the basis of appropriate information transported in the “characters”) furnished with software extensions (“plug-ins”) adapted for harnessing the “characters”. These “plug-ins” in fact ensure the interface between the machinery of the “characters” and the libraries of the web-browser.

Forthwith, the execution of particular “actions” of the “characters” transmitted will allow the interaction of the user via the standard interface of the host web-browser.

Via the MMI of the terminals (sometimes a simple audible signal)

The mechanism is similar to the previous one with the exception that the user input and display “actions” are considered by the installed operating system of the terminals.

Via other devices (telephones, machinery, etc.)

In certain applications, the activation of the “actions” can serve to activate or control an apparatus, or else to trigger the automatic opening of a GSM line for example.

### PARTICULAR EXAMPLES

Described below, by way of illustration, is a particular exemplary application.

### TERMINALS, ACCESS POINTS AND INFRASTRUCTURE

Mobile Terminals

In this example the mobile terminals consist of portable GSM telephones. These apparatuses are therefore capable of connecting up to the GSM telephone network and consequently to any web server via an access point. The GSM network is therefore in this example used to allow the connecting of the terminals to the web. They are also capable of executing proprietary software dedicated to the platform and the installed operating system ensures the standard services of display, of input of user commands, of control of the handset, of storage functions, etc. Furthermore, the portable telephones used are fitted with means capable of executing the “Java” language used to write the executable code contained in the “characters”.

These portable telephones which constitute mobile terminals are also fitted with a radio transmitter/receiver to the standard currently designated under the “bluetooth” terminology (autoaddressable digital radio linkup), therefore capable of connecting up and of automatically disconnecting according to the instructions of the programs to other equipment meeting the same standard. “Bluetooth” is therefore used here as a proximity network, the connections between mobiles occurring as dictated by their movement. Let us recall that the latter means of communication is totally independent of the standard connection of telephones to the cellular network.

Servers and Global Network

In this example, the standard infrastructure of the Internet network (web) will be used, that is to say a nebula of fully interconnected clients and servers, exchanging their information by virtue of TCP/IP. The servers of the network are accessible via static addresses. Clients and servers execute browser and server type applications, all assumed capable of executing the downloaded “Java” applications.

### FUNCTIONALITIES AND INTERACTIONS OF THE VARIOUS CONNECTION SOFTWARE AND MODULES

Main Module of the Mobile Terminals

This program, identical for all the mobile terminals, controls the functionalities specific to the system. It ensures:

1. Control of the bluetooth “local” radio

Automatic initiation of connections (by periodic scanning of the appropriate channels)

Updating of the active subnetworks

2. Management of the main event loop of the system

Loading and unloading of the “characters” as a function of the TCP/IP connections emanating from the web or of “characters” downloaded from other mobiles

Manufacture of new “characters” or of variants from local data

Appropriate execution of the code contained in the active local “characters”

3. Interface to the specific functions of the OS of the platform

Via the execution of default methods (for example: elementary dialogue box, management of the telephone, interface to the “file system”, to other ancillary peripherals, to the telephony functions and to the TCP/IP connection to the web via the GSM access point by means of a protocol such as PPP, etc.)

Main Module of the Web Servers

This program is inserted into the server in the form of a connection specific to the system and ensures the following functionalities:

1. Centralized control of the “characters” specific to the website of the server concerned

Responses to the requests for Loading & unloading the “characters” contained in the web pages (in a static manner or otherwise), or routed from external databases

appropriate execution of the code contained in the active local “characters”

2. Dynamic generation of web pages in response to particular “actions” contained in the “characters” (display of a standard dialogue box on a client set connected to the server)

3. Vice versa, manufacturing of new “characters” or of variants from local data.

### THE “CHARACTERS” OF THE SYSTEM

As already indicated, these objects comprise to the faith “programs”, associated “data”, and “keys” or indices determining the compatibility of the data and the programs, are

The only constraints exercised on these objects are:

1. The “characters” can contain all kinds of standard data as well as other characters

2. With each character is associated a collection of “actions”, which are in fact either programs acting either on this same character or on other characters. These “actions” can also trigger and control events or exterior actions (this latter functionality in fact of the virtual device drivers)

3. Each character must contain a “key” allowing characterization of its type and its pedigree (in the case of nested characters).

4. Each character must necessarily contain a certain number of default actions, the most important of which are:

The destruction of the character attached thereto

The generation of the unique “key”

The verification of compatibility of a given “key” with the “actions” of the current character, so as to guarantee that the actions of a character can correctly act on other characters (so as for example to perform a comparison of their respective data)

Illustration on a Simple Example: a Simple Transaction

Let us assume in this canonical example that one wishes to respond to a problem of supply and demand: certain terminals have a list of objects for supply and others on the contrary have a demand therefor. The system makes it possible for example to automatically trigger offers of transactions, in the course of the proximity connections between sellers and buyers.

1. Generation of the “characters”

Let us assume that two predefined types of characters, “sellers” and “buyers”, are preprogrammed into the mobile terminals (or else that they have been downloaded from a server:

“character” Seller, key 1, actions =

“sell (generically)”

“is this a buyer key? compatible key 2?” “character” Buyer, key 2, actions =

“buy (generically)”

“is this a seller key compatible key 1?” “characters” Cube, Sphere, Cone, keys 3.1 3.2 3.3 actions =

“is the key supplied compatible with the “character” of type 3.x”

“sell the object to my contact and evaluate its interest (constructed from the generic function)”

“buy the object from my contact and evaluate its interest (constructed from the generic function)”

Each user of a terminal will then program by means of any web or MMI user interface a list of seller and buyer “characters” themselves containing several instances of Cube, Sphere and/or “Cone” “characters” and store it

2. Standby phase

As explained earlier, each terminal, which is either seller or buyer, will periodically attempt to establish a connection with other terminals.

When two terminals are close enough to talk, the initiator will transmit the list of keys corresponding to the “main characters” (i.e. containing the other characters). The receiver will then verify the compatibility of these keys with the “actions” contained in his own “main characters”: thus, impossible transactions such as the buying of an object which is not for sale are automatically avoided without it being necessary to send in detail the hierarchy of the characters themselves. Next, in this example, the potentially valid transactions will automatically trigger the recursive verification of the sub-“characters” contained in the “main characters”

3. Transaction proper

According to the details of the setup, Seller and/or Buyer will then mutually apply, in the case where the keys characterizing the Cube, Sphere and Cone objects coincide, their function for evaluating the relevance for carrying out the transaction. In this simple example these functions are identical for all the instances of the objects contained in the “seller or buyer characters”. If the transaction is to be carried out (the details of the arbitration can hang multiple forms), the respective activations of the selling action in respect of the seller, and buying action in respect of the buyer allow the effective sending of the appropriate “character”.

### OTHER EXAMPLES OF MORE SOPHISTICATED APPLICATIONS

“Matching” Applications which are Context Dependent

For certain applications, it is necessary to refine the previous exchange model. Of course, the conditions under which the mobiles are put in touch with one another depend on external factors, such as for example the monetary rate of a currency, the time, the state of an inventory. These may also vary according to the value of parameters which are specific to the mobile but can vary over time, such as for example the balance of an electronic purse.

The generic example of the above paragraph must be modified in order for the relevant evaluation functions to be able to take account of the values of these variable parameters.

In the case of parameters which are totally external to the mobiles, that is to say stored or calculated on the computers of the databases connected to the servers of the global network, each transaction will require the mobile or mobiles which are present and identified as such to contact one of the servers of the global network. The latter will then allow the conveying of a request (balance, state, inventory, etc.) to the database containing the information, and of the response to this request, thus allowing the evaluation functions to conclude or otherwise the transaction. Of course, this mechanism demands that the computer coordinates of said database be contained wholly or partly in the characters exchanged.

When dealing with internal parameters, it is sufficient to carry out a prior exchange of characters between the mobiles before the transaction proper, so as to “synchronize” the two terminals to the value of the parameter foreign to one two.

Simultaneous Supply and Demand

Sometimes, it is not desirable to identify one or the other of the terminals with the specific “buyer” or “seller” function. Because the characters may very well contain as many individual criteria as desired, it is entirely possible to associate the “buying” and “selling” functions within the same character, and to do so for each of the two mobiles. The transactions will in this case be perfectly symmetric, it being possible for each mobile to be “seller”, “buyer”, or both concomitantly. An application derived directly from this variant is for example the automatic appointment-making function, for which it is necessary that two disjoint collections of constraints which cannot be communicated in full and mutually to the interested parties for confidentiality reasons be made to tally.

Latent Memory Agent

Since the users of the system will transport the device with them, it is possible to use the persistence of the data installed in the mobile terminals, so as to offset the (possible) volatility of the human memory. This is the traditional role of the “shopping list”, which can be produced here in a much more flexible and systematic manner: the user stores beforehand (by defining an appropriate character) a request containing in essence the sentence “I am looking for product X”.

As long as the character persists in the electronic memory of the mobile, it will be possible for the user to be informed at that instant that his request, long since forgotten, has finally been satisfied.

Personalized Dynamic Advertising

Because the system periodically transmits keys which summarize the state of the list of characters stored locally, it is possible for a third party to use this information, provided of course that the user has correctly activated such a function by loading an appropriate character.

It is for example possible to imagine that the user has stored a character containing for example the information “I am looking for product X”. If the user passes, in a shop for example, or a public place, in immediate proximity to a station containing a terminal of the system connected in some way to the global network (such a station would be comparable to a mobile terminal fixed at an immutable location), and if the fixed terminal is itself linked to a device for electronic display and furnished with an appropriate display “action”, it is possible to trigger the displaying of a personalized message, tailored to the profile of the consumer. The b nature of the message could well on depend on external factors such as the amount of sunshine, or the state of the shop's stock.

Automatic Relay of “Characters” and Distributed Search

The system relying on terminal-to-terminal interaction, it may be of interest to increase the probability of compatibility (“matching”) between mobiles, beyond their radio range. To do this, it is possible to decide to use other third party mobiles as “relays”. Let us assume by way of example that two terminals are requesting the same type of character. During the automatic transaction between these terminals, the similarity can be detected and give rise to an automatic and reciprocal copy of the character requested, while keeping a trace of the transmitter of origin of the character. During subsequent movements of the mobiles, it is no longer one but two terminals which will participate in the search for the “character”, by the same token doubling the probability of having the search succeed. If the terminals to which the request was sent are themselves authorized to propagate it, the probability of success increases exponentially. As soon as a “match” has been found, since the messages preserve the trace of the transmitter, it is easy to activate an action conveying the responses to the original request. A recursive search such as this requires (unlike the case of a computer virus) that the search can be stopped or in any case limited. A simple way of precluding any explosive overflow is to limit the number of copy of the initial character which can be made during transmission.

References

(1) http://www.lovefinder-europe.com

(2) IBM, Systems Journal, Vol. 35, No. 3&4, 1996, MIT Media Lab : Things that blink : Computationally augmented name tags.

(3) http://www.design.philips.com/vof/vofsite3/vof3levl /badgl/badg

(4) http://www.research.digital.com/wrl/projects/Factoi d/index.html

(5) http:/rhodes.www.media.mit.edu/people/rhodes/Rememb erance-distribution/

(6) L'usine nouvelle [The new factory], November 1998, page 32, Le corps humain comme mot de passe [The human body as password]

(7) American patents: U.S. Pat. No. 5,493,692 and U.S. Pat. No. 5,812,865, U.S. Pat. No. 5,611,050, U.S. Pat. No. 5,603,054, U.S. Pat. No. 5,555,376, U.S. Pat. No. 5,544,321.

1. A system for selective intercommunication comprising a plurality of mobile terminals which are able to be carried by a plurality of users and which comprise means allowing them to exchange pairwise, in particular when they are located in proximity to one another, as well as means allowing them to verify that the data which they exchange satisfy compatibility criteria for which said terminals have been programmed, comprising a server which is able to talk to the mobile terminals so as to send them data and program them and with which the users can connect by way of a global network, such as the Internet network, in order to configure the mobile terminals, by way of said server, characterized in that it comprises means making it possible to determine an information item regarding physical proximity between two mobile terminals and means which authorize the data exchanges between two mobile terminals only when a condition on this information item regarding proximity is satisfied.

2. The system as claimed in claim 1, characterized in that it comprises at least one local network within which the mobile terminals exchange.

3. The system as claimed in either of the preceding claims, characterized in that the mobile terminals comprise a Man Machine Interface allowing a user to configure them directly.

4. The system as claimed in one of the preceding claims, characterized in that the mobile terminals comprise means allowing their automatic reconfiguration on receipt of a character transmitted by a third party mobile terminal.

5. The system as claimed in one of the preceding claims, characterized in that the mobile terminals comprise sensors for measuring physical quantities and in that the exchange of data between two mobile terminals is authorized only when a condition relating to at least one of these physical quantities is complied with.

6. The system as claimed in one of the preceding claims, characterized in that a mobile terminal comprises means for transmitting a wakeup signal, as well as means for transmitting a signal in response to the detection of such a wakeup signal.

7. The system as claimed in one of the preceding claims, characterized in that it comprises a plurality of fixed terminals to which the mobile terminals are able to talk.

8. The system as claimed in claim 7, characterized in that the fixed terminals comprise display means able to display data received from a mobile terminal.

9. The system as claimed in one of the preceding claims, characterized in that a mobile terminal comprises means allowing it to retransmit data received from a third party mobile terminal.

10. The system as claimed in one of the preceding claims, characterized in that a mobile terminal comprises memory means in which the data corresponding to a request formulated by the user of the mobile terminal persists for as long as it has not been satisfied.
